(19) United States
(12) Patent Application Publication
(10) Pub. No.: US 2009/0220185 A1
(43) Pub. Date: Sep. 3, 2009

(54) LIGHT MODULATING DEVICE

(75) Inventors: Hiroshi Wada, Tokyo (JP); Tokihiro Terashima, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/372,077

(22) Filed: Feb. 17, 2009

(30) Foreign Application Priority Data
Feb. 28, 2008 (JP) 2008-047155

(51) Int. Cl. G02F 1/035

(52) U.S. Cl. 385/3

(57) ABSTRACT

The present invention provides an MZ light modulator that can be operated with both of a negative chirp characteristic and a zero chirp characteristic by a single device. The MZ light modulator has first and second waveguides that respectively waveguide two branched lights equal in intensity and perform optical phase modulation by application of first and second modulation voltage signals. Core layers to which modulating electric fields of the first and second waveguides are applied, are different in thickness from each other. The first and second modulation voltage signals are push-pull signals opposite in phase to each other and are different in center voltage from each other.

### BACKGROUND OF THE INVENTION

The present invention relates to a light modulating device having a Mach-Zehnder light modulator used in optical communications and an optical information processing system or the like, and particularly to control of wavelength chirp characteristics.

A Mach-Zehnder type light or optical modulator (hereinafter called also “MZ light modulator”) has been widely used as a light source of an optical communication system. The Mach-Zehnder type light modulator is of a light intensity modulator which performs On/Off of light according to an interference condition at the time that it temporarily branches or demultiplexes light into two and multiplexes the two again. The interference condition used at their multiplexion is changed by applying modulating voltages to electrodes provided on waveguides for the two demultiplexed lights.

As a method for driving such a Mach-Zehnder type light modulator, there are known single arm drive for performing modulation for only one of two arm waveguides, and double-phase arm drive (push-pull drive) for driving both arm waveguides in push-pull.

Since light modulation based on the single arm drive assumes a negative chirp characteristic that the frequency of light becomes low (its wavelength becomes long) when the intensity of light is switched from On to Off, it is suitable for long-distance optical communications. Since, however, only one arm waveguide is driven to perform the light modulation, a high modulation voltage is required.

Light modulation based on the push-pull drive is widely used because a drive voltage (modulation voltage) can be reduced. When, however, the light modulator is push/pull-driven, the light modulation assumes a positive chirp characteristic that the wavelength of outgoing light changes to the low-frequency side at the moment of transition of the intensity of light from Off to On, and assumes a negative chirp characteristic that the wavelength changes to the high-frequency side at the moment of transition of the light intensity from On to Off in reverse. The conventional push-pull drive was accompanied by a problem that the absolute value of a chirp amount was small even if the negative chirp characteristic could be obtained. For example, the value of an a parameter (which will be described later) indicative of the amount of change in the chirp characteristic is −0.2 or so.

In order to solve this problem, there has been described that a demultiplexer's branching ratio is brought to inequality or unequal division (shifted from 1:1) in such a manner that the intensity of light incident on two modulation arms from an optical demultiplexer on the incident side becomes, for example, 4:6 or 3:7, thereby to control a chirp amount, whereby a preferable negative chirp characteristic (a parameter: −0.7 or so) is obtained even in the push-pull drive (refer to, for example, a patent document 1 (U.S. Pat. No. 5,524,076)).

The above related art had however a problem that great unequal division of the branching ratio with satisfactory reproducibility (4:6, 3:7 and the like) was very difficult and the manufacturing yield was degraded. A problem also arose in that since an extinction ratio was reduced where the branching ratio was shifted from 1:1, the identification of post-transmission On/Off became difficult correspondingly. Further, a problem arose in that there was a need to make a modulation voltage higher for the purpose of obtaining an extinction ratio necessary for high-speed and long distance transmission.

There might be a demand for a zero chirp characteristic as well as a negative chirp characteristic depending on an optical communication system. For example, a metropolitan optical communication network needs to perform fiber transmission over a distance of 40 km or 80 km or so at a transmission rate of 10 Gbps by non-relay. In such a case, a negative chirp characteristic is required for a light source of a light or optical transmitter (refer to, for example, a non-patent document 1 (F. Koyama & K. Iga “Frequency chirping in external modulators”, IEEE Journal of Lightwave Technology, vol. 6, No. 1, p. 87, 1988)).

On the other hand, in the case of such a long distance transmission system that about 40 km dispersion compensating fibers are connected by repeaters to provide their connections over many periods, thereby carrying out transmission of a few 100 km to a few 1000 km, a zero chirp characteristic is required for its light source.

Although the optical modulators each having the negative and zero chirp characteristics have heretofore been realized by being designed separately by discrete devices, it is desired that the optical modulator can be implemented by a single device even at both of the negative chirp characteristic and the zero chirp characteristic.

### SUMMARY OF THE INVENTION

The present invention has been made in view of the foregoing points. It is an object of the present invention to provide a Mach-Zehnder type modulating device (MZ modulating device or modulator) which is easy to fabricate and capable of stably obtaining a desired negative chirp characteristic suitable for long distance transmission. It is also an object of the present invention to provide an MZ modulating device which can be operated with both of a negative chirp characteristic and a zero chirp characteristic by a single device.

According to one aspect of the present invention, for attaining the above objects, there is provided a light modulating device comprising a Mach-Zehnder light modulator having first and second waveguides which demultiplex incident light into two and perform optical phase modulation according to the application of modulating electric fields based on first and second modulation voltage signals, respectively, while waveguiding the two lights, and a driver circuit which generates the first and second modulation voltage signals, based on a data signal, wherein the two lights are equal in intensity and the thicknesses of core layers to which the modulating electric fields of the first and second waveguides are applied, are different from each other, and wherein the first and second modulation voltage signals are push-pull signals opposite in phase to each other, and the first and second modulation voltage signals are different in center voltage from each other.

According to the present invention, the thicknesses of the core layers of the two waveguides that perform the optical phase modulation in the MZ light modulator are made different from each other thereby to bring the configurations of the two waveguides that perform the corresponding modulation into asymmetry. The relationship between the magnitudes of the modulation voltages (center voltages) for the two modulation waveguides is changed thereby to enable implementation of both of a negative chirp operation and a zero chirp operation. Thus, a light modulating device can be provided wherein a modulation condition is changed by a single device thereby to make it possible to implement both negative chirp and zero chirp, thus enabling flexible adaptation to various different demands of a system.

Further, the negative chirp characteristic and the zero chirp characteristic can be implemented stably and with satisfactory reproducibility. Along with it, long distance transmission can be realized stabler without incurring a reduction in extinction ratio.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a diagram showing a configuration of a light modulating device illustrative of a first preferred embodiment of the present invention;

FIG. 2 is a sectional view taken along line A-A′ of an MZ light modulator shown in FIG. 1;

FIG. 3 is a diagram typically showing an example of a DC extinction curve where the MZ light modulator is singly arm-driven;

FIG. 4 is a diagram typically illustrating modulation voltages Va and Vb (see the upper stage of FIG. 4) applied where the MZ light modulator is push/pull-driven to obtain a modulated light signal having a negative chirp characteristic, and a light output waveform (see the lower stage of FIG. 4) outputted from the MZ light modulator;

FIG. 5 is a diagram showing simulation results of a parameters where the MZ light modulator is push/pull-driven by first and second modulation voltages Va and Vb; and

FIG. 6 is a diagram typically illustrating modulation voltages Va and Vb (see the upper stage of FIG. 6) applied where the MZ light modulator is push/pull-driven to obtain a modulated light signal having a zero chirp characteristic, and a light output waveform (see the lower stage of FIG. 6) outputted from the MZ light modulator.

### DETAILED DESCRIPTION OF THE PREFERRED EMBODIMENTS

Preferred embodiments of the present invention will hereinafter be described with reference to the accompanying drawings.

### First Preferred Embodiment

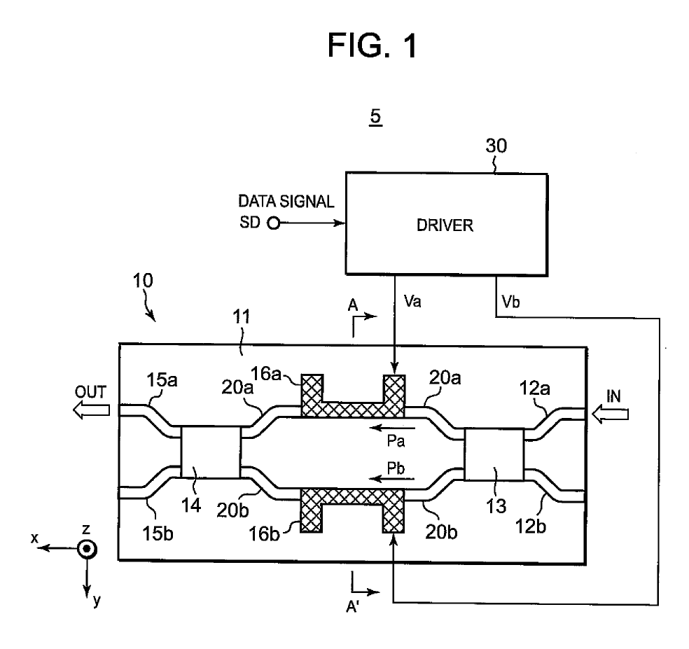

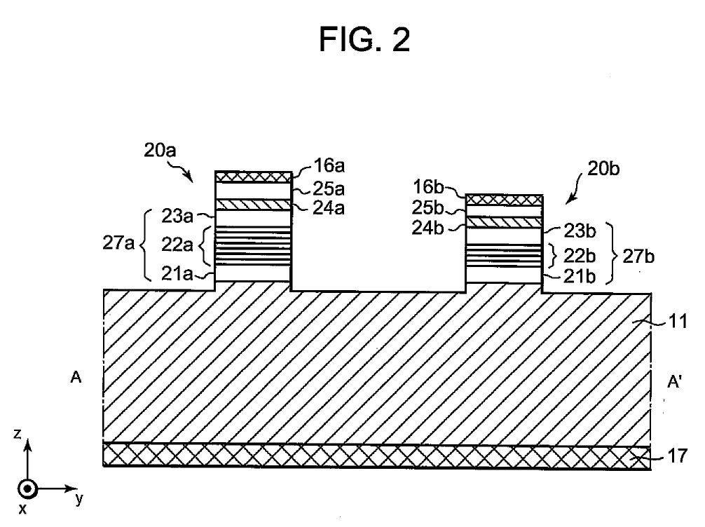

FIG. 1 is a diagram showing a configuration of a light modulating device 5 illustrative of a first embodiment of the present invention. The light modulating device 5 comprises a Mach-Zehnder light modulator (MZ light modulator) 10 and a driver (driver circuit) 30 of the MZ light modulator 10. A plan view of the MZ light modulator 10 is shown in FIG. 1. FIG. 2 is a sectional view taken along line A-A′ (FIG. 1) of the MZ light modulator 10.

### [Configuration of Light Modulating Device]

The driver circuit 30 of the light modulating device 5 is connected to a common electrode 17 and first and second modulation electrodes 16a and 16b of the MZ light modulator 10 to be described later. The driver circuit 30 is supplied with a data signal SD. The driver circuit 30 generates modulation voltages Va and Vb, based on the received data signal SD and applies the same to the first and second modulation electrodes 16a and 16b respectively. Incidentally, the operation of the driver circuit 30 will be explained in detail later.

As shown in FIG. 1, the MZ light modulator 10 is formed with a semiconductor as a substrate, for example. The MZ light modulator 10 is formed on the surface of a substrate 11 composed of InP doped with an n conductivity-type impurity, for example. The MZ light modulator 10 is provided with first and second incident waveguides 12a and 12b in which modulated light is launched. The incident waveguides 12a and 12b are connected to a light or optical demultiplexer 12. The incident light (modulated light) is demultiplexed into two by the optical demultiplexer 13, which in turn are outputted from two output ports of the optical demultiplexer 13. As the modulated light, for example, a continuous wave (CW) is launched.

Input ports of first and second arm waveguides 20a and 20b are connected to their corresponding output ports of the optical demultiplexer 13. Output ports of the first and second arm waveguides 20a and 20b are connected to a light or optical multiplexer 14.

The optical multiplexer 14 multiplexes lights supplied from the first and second arm waveguides 20a and 20b and outputs the result thereof to first and second outgoing waveguides 15a and 15b. Further, a first modulation electrode 16a and a second modulation electrode 16b are formed in the surfaces of the first and second arm waveguides 20a and 20b respectively.

The first arm waveguide 20a and the second arm waveguide 20b respectively have lower SCH (Separate Confinement Heterostructure) layers 21a and 21b formed over the surface of the substrate 11 as shown in their sections in FIG. 2. The lower SCH layers 21a and 21b are respectively formed of a non-doped semiconductor (InGaAsP, for example) undoped with an impurity, for example.

The first arm waveguide 20a comprises, for example, an MQW waveguide layer 22a having multi quantum well (MQW) layers corresponding to 25 layers, an upper SCH layer 23a, a clad layer 24a and a cap layer 25a sequentially formed on the lower SCH layer 21a. The first modulation electrode 16a is formed on the cap layer 25a. On the other hand, the second arm waveguide 20b comprises, for example, an MQW waveguide layer 22b having MQW layers corresponding to 18 layers, an upper SCH layer 23b, a clad layer 24b and a cap layer 25b sequentially formed on the lower SCH layer 21b. The second modulation electrode 16b is formed on the cap layer 25b. That is, the number of the layers that constitute the MQW waveguide in the second arm waveguide 20b is reduced as compared with the first arm waveguide 20a. Incidentally, the upper SCH layer 23b may not be provided in the second arm waveguide 20b.

More specifically, each of the MQW waveguide layers 22a and 22b is formed by laminating or stacking barrier and quantum well layers alternately. In the MQW waveguide layer 22a, the quantum well layers interposed between the barrier layers correspond to the 25 layers. In the MQW waveguide layer 22b, the quantum well layers interposed between the barrier layers correspond to the 18 layers. Here, the barrier layers and the quantum well layers are respectively formed of an InP semiconductor. Specifically, the barrier layer is formed by a non-doped InP semiconductor, whereas the quantum well layer is formed by a non-doped InGFaAsP semiconductor. For example, a barrier layer formed of InP having a thickness of 10 nm or so and a quantum well layer formed of InGaAsP having a thickness of 10 nm or so are alternately stacked on one another thereby to form the MQW waveguide layers 22a and 22b corresponding to the 25 layers and 18 layers respectively.

However, each of the barrier and quantum well layers may be formed of quaternary alloys (InGaAsP) or ternary alloys (InGaAs). Alternatively, they may be doped with impurities (n-type and p-type dopants) without being limited to or by the non-doped layers. Further, the barrier layers and the quantum well layers are not limited to layers each lattice-matched with InP. For example, each of the MQW waveguide layers 22a and 22b may be configured as a so-called strained MQW. Incidentally, the thicknesses of the barrier and quantum well layers are suitably determined depending on their crystalline textures and quantum levels, the wavelength of the modulated light, etc.

The upper SCH layer 23a is formed of the non-doped InGaAsP semiconductor in a manner similar to the lower SCH layer 21a. The upper SCH layer 23a is for confining the majority of light propagating through the first arm waveguide 20a within the MQW waveguide layer 22a along with the lower SCH layer 21a.

Incidentally, while the first arm waveguide 20a and the second arm waveguide 20b are formed as a mesa structure as shown in FIG. 2, the width of each of the first and second arm waveguides 20a and 20b is determined to assume such a suitable value (2 μm, for example) that they waveguide the propagated light suitably.

The clad layers 24a and 24b are comprised of InP doped with a p-type impurity, and the cap layers 25a and 25b are comprised of InGaAs doped with a p-type impurity. Further, a common electrode 17 is formed on the back surface of the substrate 11. Modulating voltages are applied between the common electrode 17 and the first modulation electrode 16a and between the common electrode 17 and the second modulation electrode 16b. Light or optical phase modulation corresponding to the magnitude of an electric field to be applied is conducted in field application regions (areas for forming the first modulation electrode 16a and the second modulation electrode 16b) which are parts of the first arm waveguide 20a and the second arm waveguide 20b and to which the corresponding modulating field is applied.

In the present embodiment as described above, the numbers of the quantum well layers of the multi quantum well (MQW) waveguides that constitute the first arm waveguide 20a and the second arm waveguide 20b are respectively made different from each other. Thus, the thicknesses (in the direction to apply the electric field) of core layers (hereinafter called also “modulation layers”) with the modulating fields based on the modulating voltages applied thereto in the first arm waveguide 20a and the second arm waveguide 20b, i.e., the thicknesses of portions of the waveguides to each of which the modulating field is applied and the optical phase modulation is performed, are made different from each other. However, no limitation is imposed on the differing of the numbers of the quantum well layers from each other. For example, the thicknesses of other layers are made different from each other thereby to allow the thicknesses of the core layers (modulation layers) with the modulating field applied thereto to differ from each other. More specifically, the core layer (first modulation layer) 27a of the first arm waveguide 20a comprises the lower SCH layer 21a, MQW waveguide layer 22a and upper SCH layer 23a. The core layer (second modulation layer) 27b of the second arm waveguide 20b comprises the lower SCH layer 21b, MQW waveguide layer 22v and upper SCH layer 23b. The thicknesses of the core layers 27a and 27b of the first and second arm waveguides 20a and 20b may be made different from each other by causing any of the thicknesses of these layers to differ.

### [Operation of Light Modulating Device]

The operations of the MZ light modulator 10 and the driver circuit 30 will next be explained. Assuming that when, for example, incident light IN is inputted from the first incident waveguide 12a and outgoing light OUT outputted from the first outgoing waveguide 15a is used, an electric-optical interaction length (approximately coincident with the length of the first modulation electrode 16a) and an equivalent refractive index at the first arm waveguide 20a are La and NEa respectively and an electric-optical interaction length (approximately coincident with the length of the second modulation electrode 16b) and an equivalent refractive index at the second arm waveguide 20b are Lb and NEb respectively, the state (Off state and On state) of the outgoing light OUT is expressed in the following manner. Where λ indicates the wavelength of light and n is an arbitrary integer.

Off state when (La×NEa)−(Lb×NEb)=2n×λ/2

On state when (La×NEa)−(Lb×NEb)=(2n+1)×λ/2

When the voltage is applied to either one or both of the first modulation electrode 16a and the second modulation electrode 16b here, each of the equivalent refractive indices NEa and NEb changes depending on the applied voltage and thereby the outgoing light OUT is switched between the On state and the Off state.

At this time, the intensity of the outgoing light OUT is modulated depending on the applied voltage and at the same time the wavelength of the outgoing light OUT also changes under the influence of changes in the equivalent refractive indices of the waveguides. This phenomenon is called “chirping”. The magnitude thereof is represented by a α parameter expressed in the following equation (1):

α=E(dφ/dt)/(dE/dt) (1)

where E indicates the field intensity of outgoing light OUT, and φ indicates the phase. The relationship between these E and φ can generally be expressed in the following equation (2):

$$E exp ( j φ ) = \frac{{E}_{0}}{1 + R} [ R exp \{ - ( \frac{{}^{r} a Δ α ( Va / da )}{2} + j {}^{r} a Δ β ( Va / da ) L ] + exp \{ - ( \frac{{}^{r} b Δ α ( Vb / db )}{2} + j {}^{r} b ( Δ β ( Vb / db ) + φ 0 ) L \} ] \qquad ( 2 )$$

where E0 indicates constant, R indicates the square root of a branching ratio (Pa/Pb) between the intensities of light incident to the two arm waveguides 20a and 20b, ^{Γ}a and ^{Γ}b respectively indicate light confinement coefficients at the arm waveguides 20a and 20b, Vi (where i: a or b) indicates a modulation voltage applied to the core layer (layer comprised of lower SCH layer 21, MQW waveguide layer 22 and upper SCH layer 23) based on the non-doped semiconductor to which a modulating electric field is actually applied at the first or second arm waveguide 20a or 20b, di (where i: a or b) indicates the thickness of the core layer of the first arm waveguide 20a or the second arm waveguide 20b.

Further, Δα(Vi/di) indicates a change-in-loss amount per quantum well layer constituting the first or second arm waveguide 20a or 20b, Δβ(Vi/di) indicates a change-in-propagation constant amount per quantum well layer constituting the first or second arm waveguide 20a or 20b, L indicate electric-optical interaction lengths (approximately coincident with the lengths of the first and second modulation electrodes 16a and 16b) at the first and second arm waveguides 20a and 20b, and φ0 indicates an initial phase difference that originally exists between the lights propagating through the first and second arm waveguides 20a and 20b under the condition that no voltages are applied to the first and second modulation electrodes 16a and 16b.

The first term of the equation (2) indicates the light electric field after having passed through the first arm waveguide 20a, and the second term thereof indicates the light electric field after having passed through the second arm waveguide 20b, respectively. It is understood that the entire light electric field of the outgoing light OUT is represented by assigning the weight of the branching ratio R to the two light electric fields and adding the same together. Introducing E and φ determined from the equation (2) into the equation (1) makes it possible to yield a a parameter. In the case of push/pull-type double-phase arm driving, Va and Vb satisfy the following condition.

|ΔVa|=|Vb| and Va+Vb=constant

where ΔVi (where i: a or b) means the difference between the maximum and minimum values of Vi.

In the present embodiment, the branching ratio for the incident light (modulated light) by the optical demultiplexer 13 is 1 (Pa:Pb=1:1) and the incident light (modulated light) is demultiplexed into two equal parts. Namely, since the intensities Pa and Pb of the light waveguided by the arm waveguides 20a and 20b are made equal to each other (Pa=Pb) and the first and second arm waveguides 20a and 20b are made different in structure from each other, the equation (2) is represented as given by the following equation (3):

$$E exp ( j φ ) = \frac{{E}_{0}}{2} [ exp \{ - ( \frac{{}^{r} a Δ α ( Va / da )}{2} + j {}^{r} a Δ β ( Va / da ) L \} + exp \{ - ( \frac{{}^{r} b Δ α ( Vb / db )}{2} + j {}^{r} b ( Δ β ( Vb / db ) + φ 0 ) L \} ] \qquad ( 3 )$$

Thus, the α parameter can be controlled to a desired value by suitably setting the confinement coefficients ^{Γ}a and ^{Γ}b of the first and second arm waveguides 20a and 20b, the thicknesses da and db of the core layers, etc.

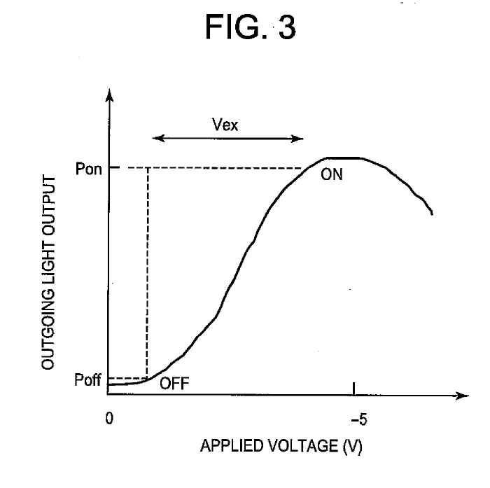

FIG. 3 typically shows an example of a DC extinction curve where the MZ light modulator 10 is singly arm-driven. In the present embodiment, the outgoing light becomes large (it is brought to On) when the absolute value of each voltage applied to the MZ light modulator 10 is made large as shown in the figure. The extinction curve is obtained where the modulation electrode of one waveguide is modulated, e.g., light is launched from the first incident waveguide 12a and only the first modulation electrode 16a is driven by its corresponding modulation voltage to apply an electric field to the first arm waveguide 20a alone. Namely, FIG. 3 shows the intensity of outgoing light OUT emitted or outputted from the first outgoing waveguide 15a. When a modulation voltage Vex is applied to the first modulation electrode 16a, a predetermined extinction ratio ER (=Poff/Pon) is obtained.

In the present embodiment, a voltage (reverse voltage) negative with respect to the common electrode 17 is applied to the first and second modulation electrodes 16a and 16b thereby to perform light or optical modulation.

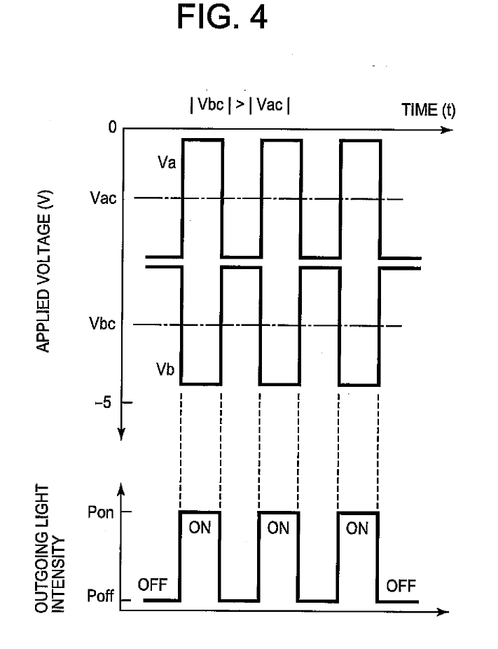

FIG. 4 typically illustrates modulation voltages Va and Vb where the MZ light modulator 10 is push/pull-driven to obtain a modulated pulse having a negative chirp characteristic (see the upper stage of FIG. 4). Incidentally, a light or optical output waveform (modulated light signal) outputted from the MZ light modulator 10 when the modulation voltages Va and Vb are applied, is typically shown at the lower stage of FIG. 4.

In the present embodiment, the driver circuit 30 applies a modulation voltage signal Va between the common electrode 17 and first modulation electrode 16a of the MZ light modulator 10 and applies a modulation voltage signal Vb between the common electrode 17 and the second modulation electrode. As described above, the driver circuit 30 is supplied with a data signal SD. The driver circuit 30 generates modulation voltage signals (hereinafter called simply “modulation voltages”) Va and Vb, based on the data signal SD. Namely, the driver circuit 30 generates modulation voltage signals Va and Vb at which a desired extinction ratio ER is obtained, in response to the data signal SD.

The driver circuit 30 applies first and second modulation voltages Va=Vac and Vb=Vbc corresponding to push-pull signals opposite in phase to each other to the first modulation electrode 16a and the second modulation electrode 16b respectively. Here, the first and second modulation voltages Va and Vb are voltages (reverse voltages) negative with respect to the common electrode 17. Vac (<0) and Vbc (<0) are respectively center voltage values (hereinafter called also “bias voltages”) of the first and second modulation voltages and different from each other (Vac≠Vbc). Incidentally, the first and second modulation voltage signals Va and Vb are rectangular-wave pulse signals constant in amplitude.

It is preferable that the first and second modulation voltages Va and Vb are equal to each other in amplitude (|ΔVa|=|ΔVb|) and the sum thereof is constant (Va+Vb=constant). The absolute value of the difference between the center voltages Vac and Vbc of the first and second modulation voltages is equal to the amplitude of the first or second modulation voltage (i.e., |Vac−Vbc|=|ΔVa|/2=|ΔVb|/2). Incidentally, FIG. 4 typically shows such a case.

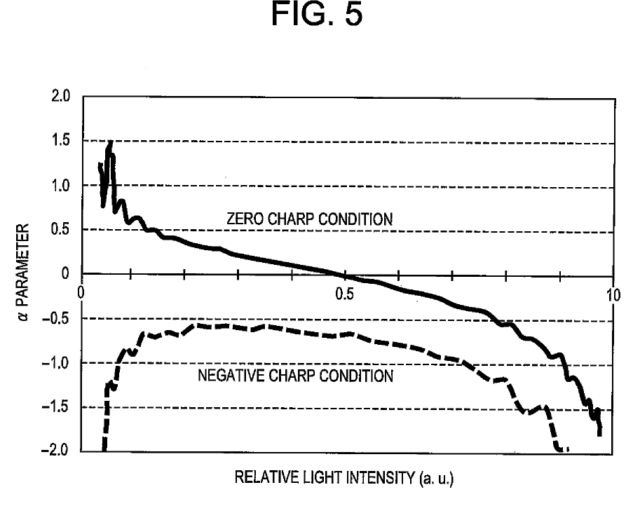

FIG. 5 shows simulation results of a parameters each expressed in the equation (1) where the MZ light modulator 10 is push/pull-driven by the first and second modulation voltages Va and Vb. The horizontal axis indicates the relative value of a light intensity, and the vertical axis indicates the a parameter.

When the center voltage Vbc of the second modulation voltage Vb (<0) applied to the second modulation electrode 16b is smaller than the center voltage (bias voltage) Vac (<0) of the first modulation voltage Va applied to the first modulation electrode 16a, that is, when the absolute value of the center voltage Vbc of the second modulation voltage Vb is larger than the absolute value of the center voltage Vac of the first modulation voltage Va (|Vbc|>|Vac|), a negative chirp operation is obtained (indicated by a broken line in FIG. 5). More specifically, when the value of an a parameter at the time that the relative value of the light intensity is 0.5, is defined as the a parameter of the light modulating device 5, the a parameter is about −0.7. This shows that the optimum value has been obtained.

Thus, the center voltage (bias voltage) Vbc of the second modulation voltage applied to the second arm waveguide 20b in which the core layer (modulation layer) to which the modulating field is applied is thin in thickness, is made smaller than the center voltage Vac of the first modulation voltage Va applied to the first arm waveguide 20a thick in the core layer (the absolute value thereof is made large), thereby obtaining an a parameter (about −0.7) corresponding to a negative chirp operation and large in absolute value.

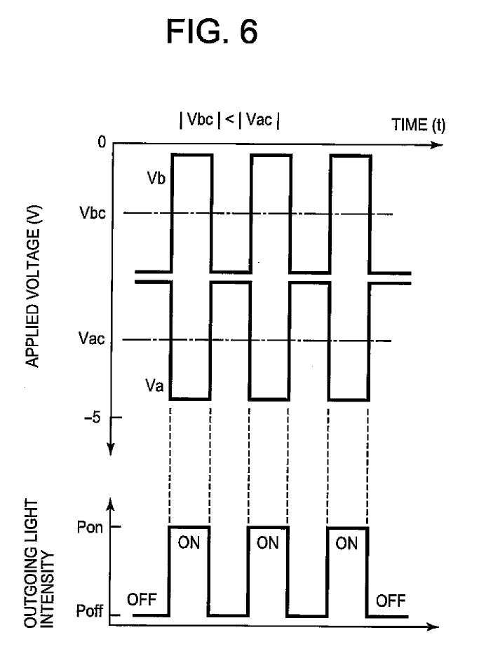

On the other hand, FIG. 6 typically shows modulation voltages Va and Vb where the MZ light modulator 10 is push/pull-driven to obtain a modulated pulse having a zero chirp characteristic (see the upper stage of FIG. 6). Incidentally, a light or optical output waveform (modulated light signal) outputted from the MZ light modulator 10 at the time that the modulation voltages Va and Vb are applied thereto, is typically illustrated at the lower stage of FIG. 6.

Namely, contrary to the above modulation condition (FIG. 4), the center voltage Vbc of the second modulation voltage applied to the second arm waveguide 20b in which the core layer (modulation layer) to which the modulating electric field is applied, is thin in thickness, is made larger than the center voltage Vac of the first modulation voltage Va applied to the first arm waveguide 20a thick in the core layer (the absolute value thereof is small)(|Vbc|<|Vac|), thereby implementing a zero chirp operation. It is understood that the a parameter is approximately zero due to the corresponding zero chirp operation condition as indicated by a solid line in FIG. 5.

Incidentally, when the polarity of the MZ light modulator 10 is opposite to the above embodiment, i.e., the waveguides 20a and 20b are formed on the p-type substrate 11 and the clad layers 24a and 24b and cap layers 25a and 25b are respectively formed of the n-type semiconductor, the polarities of the first and second modulation voltages are also opposite to the above embodiment. Namely, the first and second modulation voltages Va and Vb are positive (Va>0 and Vb>0). When, in this case, the absolute value of the center voltage Vbc of the second modulation voltage Vb applied to the second arm waveguide 20b thick in core layer is larger than the absolute value of the center voltage Vac of the first modulation voltage Va, the negative chirp operation is obtained. In the case opposite to it, the point of the zero chirp operation being reached is similar to the above.

According to the present invention as described above, the thicknesses of the core layers of the two waveguides that perform the optical phase modulation in the MZ light modulator are made different from each other thereby to introduce asymmetry into the configurations of the two waveguides that perform the corresponding modulation. The modulation voltages (relationship between the magnitudes of the center voltages) for the modulation waveguides are changed thereby to enable the selection of either of modes for the negative chirp operation and the zero chirp operation. Thus, a light modulating device can be provided wherein the modulation condition is changed by the single device thereby to make it possible to implement both negative chirp and zero chirp, thus enabling flexible adaptation to various different demands of a system.

As to the asymmetry between the modulation waveguides as described above, the thicknesses of the core layers of the two waveguides may be made asymmetric by causing the thicknesses of other layers such as the SCH layers to differ from each other under the same number of quantum wells than causing the numbers of the quantum wells to differ from each other.

When the branching ratio of each light demultiplexer is shifted from 1, the extinction ratio (ratio between the light intensities at the time that the light or optical output is On and Off) becomes small correspondingly. In the present embodiment, however, the branching ratio of the incident light (modulated light) by the optical demultiplexer 13 is 1 (Pa/Pb=1), and the intensities Pa and Pb of light waveguided by the arm waveguides 20a and 20b, i.e., the intensities of the modulated light are equal at both waveguides.

Thus, further according to the present embodiment, the negative chirp characteristic and the zero chirp characteristic can be implemented stably and with satisfactory reproducibility. Along with it, long distance transmission can be realized stabler without incurring a reduction in extinction ratio.

### Second Preferred Embodiment

The above embodiment has explained the MZ light modulator wherein the thicknesses of the core layers (thicknesses of modulation layers) of the first and second arm waveguides are made asymmetric. In the present embodiment, first and second arm waveguides are identical in layer structure and core layers are set equal in thickness. However, a branching ratio of an optical demultiplexer 13 is shifted from 1, and the intensities Pa and Pb of light waveguided by the first and second arm waveguides 20a and 20b differ from each other (Pa≠Pb).

A description will hereinafter be made, as an example, of the case where the intensity (Pb) of light waveguided by the second arm waveguide 20b is larger than the intensity (Pa) of light waveguided by the first arm waveguide 20a (Pa<Pb).

Even in such a case, both negative and zero chirp operations can be realized by performing modulation in a manner similar to the first preferred embodiment. Described more specifically, a driver circuit 30 applies first and second modulation voltages Va and Vb corresponding push-pull signals opposite in phase to each other to their corresponding first and second modulation electrodes 16a and 16b.

When, in this case, the MZ light modulator is push/pull-driven in such a manner that the absolute value (|Vbc|) of a center voltage (bias voltage) of a modulation voltage applied to the waveguide (second arm waveguide 20b) in which the intensity of the waveguided light is large, becomes larger than the absolute value (|Vac|) of a center voltage of a modulation voltage applied to the other waveguide (first arm waveguide 20a) (|Vac|<|Vbc|), a modulation operation of a negative chirp characteristic is realized.

Conversely, when the MZ light modulator is push/pull-driven in such a manner that the absolute value (|Vbc|) of the center voltage of the modulation voltage applied to the waveguide (second arm waveguide 20b) in which the intensity of the waveguided light is large, becomes smaller than the absolute value (|Vac|) of the center voltage of the modulation voltage applied to the other waveguide (first arm waveguide 20a) (|Vac|>|Vbc|), a modulation operation of a zero chirp characteristic is realized.

Thus, even if the thicknesses of the core layers are identical, either of modes for the negative chirp operation and the zero chirp operation can selectively be executed by introducing asymmetry into the intensities of light waveguided by the waveguides thereby to provide asymmetry and changing the modulation voltages (center voltages) to the modulation waveguides. Thus, a light modulating device can be provided which is capable of realizing both negative chirp and zero chirp by changing a modulation condition by means of a single device thereby to adapt to various different demands of a system with flexibility.

While the preferred forms of the present invention have been described, it is to be understood that modifications will be apparent to those skilled in the art without departing from the spirit of the invention. The scope of the invention is to be determined solely by the following claims.

What is claimed is:

1. A light modulating device comprising:
a Mach-Zehnder light modulator having first and second waveguides which demultiplex incident light into two and perform optical phase modulation according to the application of modulating electric fields based on first and second modulation voltage signals, respectively, while waveguiding the two lights; and
a driver circuit which generates the first and second modulation voltage signals, based on a data signal,
wherein the two lights are equal in intensity and the thicknesses of core layers to which the modulating electric fields of the first and second waveguides are applied, are different from each other, and
wherein the first and second modulation voltage signals are push-pull signals opposite in phase to each other, and the first and second modulation voltage signals are different in center voltage from each other.

2. The light modulating device according to claim 1, wherein the core layer of the first waveguide comprises a lower light confinement layer, an upper light confinement layer and multi quantum well layers corresponding to plural layers interposed between the lower and upper light confinement layers, and
wherein the core layer of the second waveguide comprises a lower light confinement layer and multi quantum well layers smaller in layer number than the first waveguide.

3. The light modulating device according to claim 1, wherein the core layers of the first and second waveguides respectively have a lower light confinement layer, an upper light confinement layer and multi quantum well layers of the same number interposed between the lower and upper light confinement layers, and
wherein the lower and upper light confinement layers of the first waveguide and the lower and upper light confinement layers of the second waveguide are respectively formed to different thicknesses.

4. A light modulating device comprising:
a Mach-Zehnder light modulator having first and second waveguides which demultiplex incident light into two and perform optical phase modulation according to the application of modulating electric fields based on first and second modulation voltage signals, respectively, while waveguiding the two lights; and
a driver circuit which generates the first and second modulation voltage signals, based on a data signal,
wherein the two lights are different in intensity and the thicknesses of core layers to which the modulating electric fields of the first and second waveguides are applied, are equal to each other, and
wherein the first and second modulation voltage signals are push-pull signals opposite in phase to each other, and the first and second modulation voltage signals are different in center voltage from each other.

5. The light modulating device according to claim 4, wherein the first and second modulation voltage signals are equal in amplitude to each other.

6. The light modulating device according to claim 5, wherein the absolute value of a difference between the center voltages of the first and second modulation voltage signals is equal to the amplitudes of the first and second modulation voltage signals.

7. The light modulating device according to claim 1, wherein the first and second modulation voltage signals are equal in amplitude to each other.

8. The light modulating device according to claim 7, wherein the absolute value of a difference between the center voltages of the first and second modulation voltage signals is equal to the amplitudes of the first and second modulation voltage signals.
